(19) United States
(12) Patent Application Publication
(10) Pub. No.: US 2006/0089243 A1
(43) Pub. Date: Apr. 27, 2006

(54) Duplex bag

(76) Inventor: Anthony Roger, Sartrouville (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/504,045

(22) PCT Filed: Feb. 4, 2003
(86) PCT No.: PCT/FR03/00333

§ 371 Date: Apr. 25, 2005

(30) Foreign Application Priority Data
Feb. 5, 2002 (FR) 02/01328

(51) Int. Cl. B31B 1/86

(52) U.S. Cl. 493/88

(57) ABSTRACT

The invention concerns a method for making packaging bags (1) with a double wall (31; 31), characterized in that it comprises steps which consist in: unwinding a first packaging sheet (31) wherein a window is cut out or precut; unwinding a second packaging sheet (32) wherein another window is cut out or precut; applying a closure assembly (5) on the moving packaging sheet, perpendicular to a window; fixing the closure assembly on the packaging sheet; fixing the two packaging sheets one on the other to form a double wall, said sheet being then formed into a packaging bags (1).

### OVERALL TECHNICAL FIELD

The invention relates to the field of packaging sachets.

Numerous packaging sachets and numerous systems for manufacturing them have already been proposed.

For thin sachets, usually flat, in a filled state, the known means give overall satisfaction. In this case, the sachets are generally made from two flat sheets welded together along three sides and bearing means for sealing, for example complementary male/female sections at the opening of the sachets.

On the other hand until now, the making of sachets for bulky items, irrespective of their nature, has proved unsatisfactory, despite numerous studies in this very specific field.

In particular, such sachets often require relatively thick walls, and it is not easy to attach means for sealing to such walls.

This applying of the means for sealing is all the more delicate when the means for applying are not located at the opening of the packaging sachet, but on a surface of the sachet.

We have diagrammatically illustrated in the annexed FIG. 1 a known technique for manufacturing sachets comprising means for sealing 5 attached to a wall 3 of the packaging sachet 1, and not at the opening 2 of the packaging sachet.

The means for sealing 5 are welded or stuck to points 6 on the front wall 3 of the bag 1.

The points of application are made on the means for applying 7 of the means for sealing 5. These means for applying 7 comprise films, for example made in plastic.

The means for sealing 5 can also comprise means 8 forming runners facilitating the opening and closing of the means for sealing 5.

Examples of such known bags are disclosed and illustrated in documents U.S. Pat. No. 4,335,817 and EP 0 843 636.

The sachets, according to the prior art, however, comprise inconveniences.

Notably, the points of application 6 are not entirely sound.

Such sachets do not envisage the applying of means for applying on sachets comprising double-layer walls, that meaning double ply bags.

### PRESENTATION OF THE INVENTION

The invention proposes to overcome these inconveniences.

For this reason the invention proposes a method for manufacturing double-ply packaging sachets characterised in that it comprises the stages according to which:
we feed a first packaging sheet on which we cut out a window patch;
we feed a second packaging sheet on which we cut out another window patch;
we attach a set of seals to a fed-through packaging sheet, perpendicular to the window patch;
we attach the set of seals to the packaging sheet;
we attach the two packaging sheets to each other to form a double ply sheet, this sheet then being formed into a packaging sachet.

The invention is advantageously completed by the following characteristics taken singly or in any technically possible combination:
we attach the set of seals between the two packaging sheets, so that the means for applying the set of seals are incorporated between the two packaging sheets;
we attach the set of seals to one of the two packaging sheets, the double ply formed by the other packaging sheet not covering the means for applying the set of seals;
we weld the means for applying the set of seals to the packaging sheet;
we stick the means for applying the set of seals to the packaging sheet;
we cut out at least the window patch intended for the external wall of the double ply sachet with a pre-cut dotted line so that the wall of the sachet is capable of forming a seal covering the set of seals on the front of the sachet and being of tamper-proof type prior to the first opening; and
we attach an adhesive strip opposite the window patch of the external wall, this strip thus constituting a tamper-proof element to be stripped off upon the first opening of the sachet.

The invention relates to sachets produced by this method as well as the machines for implementing the method according to the invention.

### PRESENTATION OF THE FIGURES

Other characteristics, purposes and advantages of the invention will be revealed through the description that follows which is clearly illustrative and non restrictive and which must be read in relation to the annexed drawings in which:

FIG. 1, already evoked, diagrammatically represents a bag according to the prior art comprising an opening on one single ply wall;

FIG. 2 diagrammatically represents a front view of a double ply bag comprising an opening on one wall of the bag;

FIG. 3 represents a first method for applying an opening and a set of fastening between the two sheets of a wall of a double ply bag;

FIG. 4 represents another method for applying means for sealing on a double ply bag;

FIG. 5 represents an embodiment where a packaging sachet comprises on its surface means for sealing a pre-cut window patch forming a “tamper-proof strip”;

FIG. 6 represents an embodiment where a packaging sachet comprises on its surface means for sealing an adhesive strip forming a tamper-proof strip;

FIG. 7 represents an embodiment in which openings are formed on the upper part of the sachet once filled and thus allows to form a grip handle;

FIG. 8 represents an embodiment according to which the means for gripping are formed by straps attached to the upper part of the packaging bag; and

FIG. 9 diagrammatically represents a machine assembly allowing to attach means for sealing and to manufacture double ply bags.

### DETAILED DESCRIPTION OF THE INVENTION

As previously indicated the invention relates to the producing of re-sealable sachets using automatic machines, these sachets comprising a double ply wall.

This invention can apply as much to horizontal feed through automatic sachet production machines as to vertical feed through automatic sachet production machines.

Furthermore, the invention applies as much to automatic sachet production machines with filling during a stage subsequent to the production and possibly geographically separate from the production site as to production machines with filling and sealing—of “FORM, FILL, SEAL” (FFS) type—on a single site and in successive stages.

Thus the invention preferably and advantageously applies to FFS type vertical feed through machines.

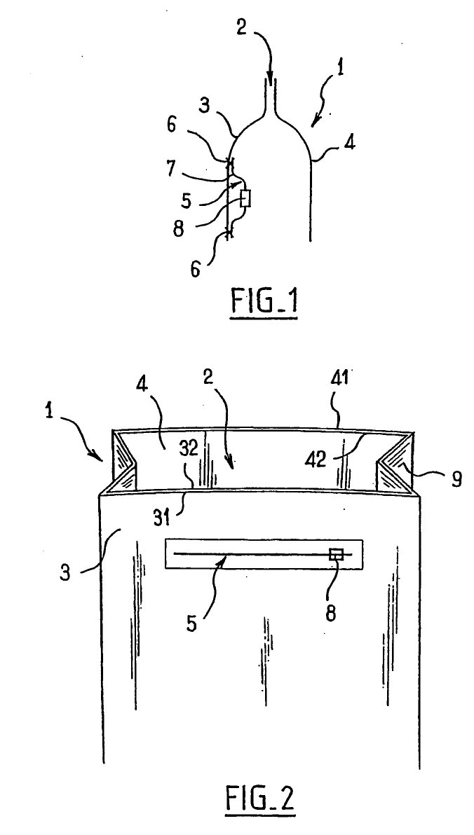

We have diagrammatically represented in FIG. 2 a bag 1 intended to receive thick contents, which will be for example inserted into the bag 1 by the opening 2, this bag 1 principally comprising two walls 3 and 4.

Such a sachet 1 is formed according to a known technique by the folding on itself of a packaging sheet so as to form a bag. The bag 1 comprises for example, but not obligatorily gussets 9 on its sides. We can advantageously refer to the applicant FR 2 758 761 in order to understand the forming and producing of such sachets.

We have designated the front wall of the bag 1 with 3 and the rear wall of the bag 1 with 4.

The front wall 3 comprises a set of seals 5 this set of seals 5 comprising for example but not obligatorily means 8, facilitating the opening and the closing of the means for sealing the set 5. The means 8 will be for example formed by a runner that can be moved along known complementary sealing sections.

The set of seals 5 can also comprise means for sealing that do not comprise male/female type complementary sealing sections.

The set of seals can comprise a U-shaped or W-shaped film, or any known shape.

Additionally, the set 5 can comprise a film covering the means for sealing, and allowing to form a “tamper-proof” type film. The film is opened upon the first opening of the sachet by the tearing of a line of weakness made in the film material, this line of weakness can comprise dotted lines.

The walls of sachet 1 comprise two pieces, called plies. We have designated in FIG. 2 the exterior ply of the wall 3 with 31 and the interior ply of the wall 3 with 32. We have also designated the exterior ply of the wall 4 with 41 and the ply of the wall 4 with 42, the ply 42 being on the inside of the sachet 1.

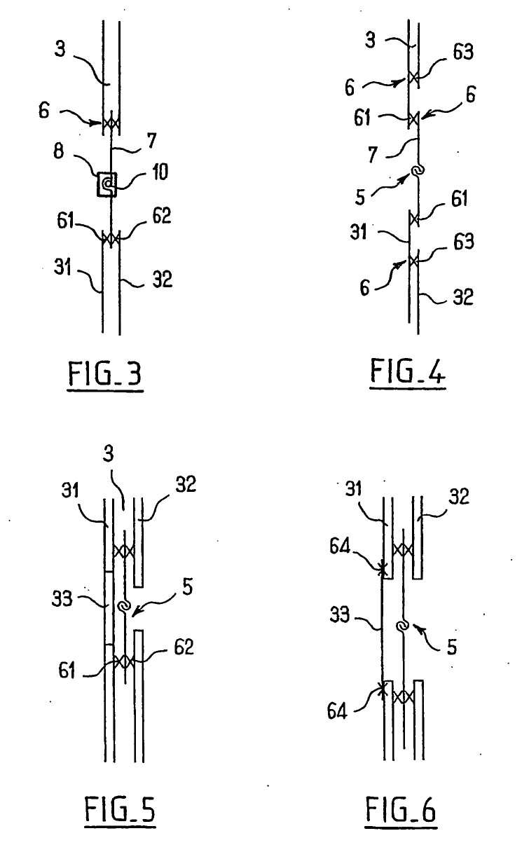

FIG. 3 diagrammatically represents the attaching the set of seals 5 to the inside of the double ply wall 3.

According to the invention, the set of seals 5 comprises means for applying 7. These means for applying 7 will be for example formed by side films, in whatsoever material. The side films can thus be composed of typical material, but also of paper or carton type material.

According to the invention, these means for applying 7 are attached at points 6 to the wall of the bag 1.

The points of application 6 comprise, according to a first embodiment represented in FIG. 3, a first point of application 61 which attaches the means for applying 7 to the ply 31, and a second point of application 62 attaching the means for applying 7 to ply 32.

This embodiment has the advantage over the embodiment of the prior art of allowing the very sound attachment of the set of seals 5 to a double ply bag.

In FIG. 3, we have represented a set of seals 5 comprising means forming male/female type complementary sections 10 as well as means forming the runner 8 allowing to easily open and close these means for sealing 10.

The runner can be in either metal or plastic.

Other means for sealing can obviously be attached to such a wall 3, for example means that do not comprise sealing runners, or means for sealing that do not comprise complementary sections.

FIG. 4 represents another embodiment for the attachment of a set of seals 5 to a wall 3.

According to this embodiment, the wall 3 comprises points of application 6 which are not overlaid.

Indeed, the means for applying the set 5 are attached to ply 31 by a point of application 61, even though they are not attached to ply 32 of the wall 3.

In the embodiment represented in FIG. 3, the ply 32 does not have exactly the same dimensions as ply 31. In other words, the cut-out window patch in ply 32 allowing a user to gain access to the inside of the bag has greater dimensions than the window patch pierced in ply 31 of the bag 1, the latter window patch allowing access to means for sealing the bag.

The ply 32 is attached to ply 31 by points of application indicated by 63 in FIG. 4.

In FIG. 4, we have represented means for sealing that do not comprise opening and closing runners. The means for sealing comprise male/female type complementary sections, but an alternative to this embodiment comprising means for sealing that do not have such sections is conceivable.

FIG. 5 represents an alternative to the embodiment represented in FIG. 3. According to this alternative, the ply 31 does not comprise an opening allowing direct access for the user to the set of seals 5.

According to this alternative, the window patch 33 is pre-cut out of the ply 31, without being totally open. Thus, the means for sealing 5 are not accessible from the outside of the sachet. The pre-cut window patch 33 thus constitutes a “tamper-proof” type seal allowing to indicate to the user that the sachet has never been opened.

Come the first opening of the sachet 1, the user will cut the tamper-proof window patch 33 along the dotted line on the ply 31. For this reason, the dotted line constitutes a line of weakness in the ply 31 allowing to easily open the tamper-proof window patch 33.

The pre-cut dotted line can be of another type, for example a line of weakness with a lesser thickness in the case for example of plies made in plastic.

In FIG. 5, the tamper-proof window patch is located on the ply 31. We can also envisage placing a tamper-proof window patch on the ply 32, retaining or not the tamper-proof type window patch on the ply 31.

FIG. 6 represents another alternative of the sachet represented in FIG. 3, according to which the tamper-proof window patch is no longer constituted of a pre-cut window patch on the ply 31, but is constituted of an adhesive strip 33 which is stuck to the perimeter of the window patch open in the ply 31, the stickiness being made via the points of application 64 located on the exterior of the sachet.

This relatively strong stickiness allows to form a perfect tamper-proof type seal perpendicular to the set of seals 5.

This adhesive strip 33 can be constituted of a plastic type material.

As in the alternative represented in FIG. 5, this adhesive strip can also be stuck to the wall on the inside of the bag on the ply 32. The choice of an adhesive strip on the ply 31 and/or 32 is made independently from each other.

We can also for example place an adhesive strip, as represented in FIG. 6, on a tamper-proof window patch of the type represented in FIG. 5.

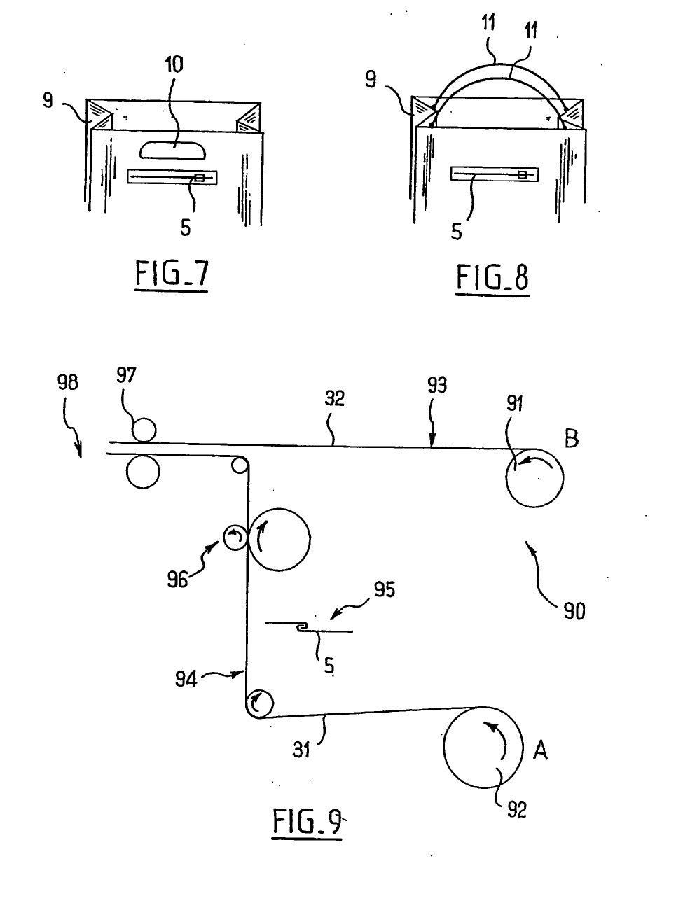

FIG. 7 represents a bag according to the invention in which we have pierced two window patches 10 in the upper part allowing to form means for gripping so as to carry the packaging bag.

FIG. 8 represents an alternative according to which the means for gripping are constituted of straps 11.

The attaching of the straps or cords 11 can be ensured via sticking or via stringing said straps in holes made in the upper part of the sachet. The stringing is followed by a stage in which we stick on the upper part of the sachet or we tie the straps in the purposely made holes.

Alternatively, the bag could only comprise a single strap or cord forming a handle.

The walls of the packaging bag can be indiscriminately made in plastic material, paper or carton type material. The walls can for example be constituted of an interior ply in a material, the exterior ply being in another material.

FIG. 9 diagrammatically represents a machine allowing to perform the method of forming and manufacturing sachets according to the invention.

A first packaging sheet 31 is reeled off a paper roller 92.

In stage 94, a window patch is pierced or pre-cut.

At point 95, a set of seals 5 is attached perpendicular to the pierced or pre-cut window patch.

In stage 96 we weld or stick the means for applying the set of seals to the perimeter of the pierced or pre-cut window patch. The stage 96 can for example be carried out thanks to the feeding through of the sheet between two feed-through rollers visible in FIG. 9.

We are mindful that the set of seals is of any type and that it does or does not comprise a runner.

Simultaneous to the feeding through of the sheet 31, a packaging sheet 32 is reeled off the roller 91.

In stage 93 we pierce or pre-cut a window patch of similar size or of a different size to the pierced or pre-cut window patch at point 94, according to the embodiment that we wish to obtain (see FIGS. 3 and 4).

The sheet 32 continues to be reeled off so as to simultaneously arrive at point 97 with the sheet 31. At this stage, we back the sheet 32 to the sheet 31 so as to obtain a double ply packaging sheet.

The piercing or pre-cutting of the window patches at stages 93 and 94 is synchronized, so that the window patches lie perpendicular to each other when they arrive at point 97. The stage 97 can for example be carried out thanks to the feeding through of the sheets between two feed-through rollers visible in FIG. 9.

We envisage starting from point 98 methods and machines for lateral welding so as to form the bag, with or without side gussets, its filling before sealing the upper opening of the bag.

Stage 98 can also comprise the piercing of the means for gripping of handle type or the attaching of straps and cords forming means for gripping. It can be carried out at a different site than that of the stages represented in FIG. 9, at times near or relatively distant.

We are mindful that the diagram in FIG. 9 does not whatsoever assume the position of the machine. For example, it could be a vertical or horizontal feeding through and that the attaching of the set of seals 5 can be carried out longitudinally or transversally to the feeding through of the packaging sheet 31.

1. Method for manufacturing double ply (31, 32) packaging sachets (1) characterised in that it comprises the stages according to which:
we feed a first packaging sheet (31) on which we cut out or pre-cut a window patch;
we feed a second packaging sheet (32) on which we cut out or pre-cut another window patch;
we attach a set of seals (5) to a fed-through packaging sheet, perpendicular to a window patch;
we attach the set of seals to the packaging sheet;
we attach the two packaging sheets to each other to form a double ply sheet, this sheet then being formed into a packaging sachet (1).

2. Method set forth in claim 1, characterised in that we attach the set of seals (5) between the two packaging sheets (31, 32), so that the means for applying the set of seals is incorporated between the two packaging sheets.

3. Method set forth in claim 1, characterised in that we attach the set of seals to one of the two packaging sheets (31, 32), the double ply formed by the other packaging sheet not covering the means for applying the set of seals.

4. Method set forth in one of claims 1 to 3, characterised in that we weld the means for applying the set of seals to the packaging sheet.

5. Method set forth in one of claims 1 to 3, characterised in that we stick the means for applying the set of seals to the packaging sheet.

6. Method set forth in one of claims 1 to 5, characterised in that the times of cutting out window patches are synchronised so that the window patches lie opposite each other come the subsequent joining of the packaging sheets in order to form the double ply sheet.

7. Method set forth in one of claims 1 to 6, characterised in that we cut out at least the window patch intended for the external wall (31) of the double ply sachet with a pre-cut dotted line, so that the wall of the sachet is capable of forming a seal covering the set of seals on the front of the sachet and being of tamper-proof type prior to the first opening.

8. Method set forth in one of claims 1 to 7, characterised in that we cut out the window patch intended for the internal wall (32) of the double ply sachet with a pre-cut dotted line, so that the interior wall of the sachet is capable of forming a seal covering the set of seals on the inside of the sachet and being of tamper-proof type prior to the first opening.

9. Method set forth in one of claims 1 to 8, characterised in that we attach an adhesive strip (33) opposite the window patch of the external wall, this strip thus constituting a tamper-proof element to be stripped off upon the first opening of the sachet.

10. Method set forth in one of claims 1 to 9, characterised in that we form packaging sachets by folding the double ply sheet on itself.

11. Method set forth in one of claims 1 to 10, characterised in that we fold the double ply sheet in order to obtain gussets (9) on the sides of the sachet.

12. Method set forth in one of claims 1 to 11, characterised in that we bring the set of seals transversally in relation to the feed through direction of the packaging sheet.

13. Method set forth in one of claims 1 to 11, characterised in that we bring the set of seals longitudinally in relation to the feed through direction of the packaging sheet.

14. Method set forth in one of claims 1 to 13, characterised in that the set of seals comprises a runner (8) facilitating the opening and the closing of the means for sealing the set.

15. Method set forth in one of claims 1 to 14, characterised in that the set of seals comprises complementary sealing sections.

16. Method set forth in one of claims 1 to 15, characterised in that the set of seals comprises a sealing film located towards the outside or inside of the sachet, and covering the means for sealing the set of seals, so that said film constitutes a tamper-proof element prior to the first opening of the sachet.

17. Method set forth in claim 16, characterised in that the sealing film comprises a line of weakness capable of being torn upon the first opening of the sachet.

18. Method set forth in one of claims 1 to 17, characterised in that at least one packaging sheet is a sheet made in plastic material.

19. Method set forth in one of claims 1 to 18, characterised in that at least one packaging sheet is a sheet made in paper type material.

20. Method set forth in one of claims 1 to 19, characterised in that at least one packaging sheet is a sheet made in carton type material.

21. Method set forth in one of claims 1 to 20, characterised in that the double ply packaging sheet is sent to a method for forming and filling of FFS type.

22. Method set forth in one of claims 1 to 21, characterised in that we make an opening forming a handle at the top of the packaging sachet.

23. Method set forth in one of claims 1 to 21, characterised in that we attach at least a grip strap forming a handle at the top of the packaging sachet.

24. Double ply packaging sachet characterised in that it comprises:
a first packaging sheet (31) comprising a window patch;
a second packaging sheet (32) comprising another window patch;
a set of seals (5) attached to a packaging sheet, perpendicular to a window patch;
the two packaging sheets being attached to each other so as to form a double ply sheet, this sheet forming said packaging sachet (1).

25. Sachet set forth in claim 24, characterised in that the set of seals (5) is located between the two packaging sheets, so that the means for applying the set of seals are incorporated between the two packaging sheets.

26. Sachet set forth in claim 25, characterised in that the set of seals is attached to one of the two packaging sheets (31), the double ply formed by the other packaging sheet not covering the means for applying the set of seals.

27. Sachet set forth in one of claims 24 to 26, characterised in that at least the window patch intended for the external wall of the double ply sachet comprises a pre-cut dotted line, so that the wall of the sachet forms a seal covering the set of seals on the front of the sachet and being of tamper-proof type prior to the first opening.

28. Sachet set forth in one of claims 24 to 27, characterised in that the window patch intended for the internal wall of the double ply sachet comprises a pre-cut dotted line, so that the interior wall of the sachet forms a seal covering the set of seals on the inside of the sachet and being of tamper-proof type prior to the first opening.

29. Sachet set forth in one of claims 24 to 28, characterised in that it comprises an adhesive strip on the external wall of the sachet and covering the set of seals of the sachet, this adhesive strip constituting a tamper-proof element prior to the first opening of the sachet.

30. Sachet set forth in one of claims 24 to 29, characterised in that it comprises gussets on its sides.

31. Sachet set forth in one of claims 24 to 30, characterised in that the set of seals comprises a runner facilitating the opening and the closing of the means for sealing the set.

32. Sachet set forth in one of claims 24 to 31, characterised in that the set of seals comprises complementary sealing sections and/or a runner.

33. Sachet set forth in one of claims 24 to 32, characterised in that the set of seals comprises a sealing film located towards the outside or inside of the sachet, and covering the means for sealing the set of seals, so that said film constitutes a tamper-proof element prior to the first opening of the sachet.

34. Sachet set forth in claim 33, characterised in that the sealing film comprises a line of weakness capable of being torn upon the first opening of the sachet.

35. Sachet set forth in one of claims 24 to 34, characterised in that it comprises at least one packaging sheet which is a sheet made in plastic material.

36. Sachet set forth in one of claims 24 to 35, characterised in that it comprises at least one packaging sheet which is a sheet made in paper type material.

37. Sachet set forth in one of claims 24 to 36, characterised in that it comprises at least one packaging sheet which is a sheet made in carton type material.

38. Sachet set forth in one of claims 24 to 37, characterised in that it comprises an opening on its upper part forming a grip handle.

39. Sachet set forth in one of claims 24 to 37, characterised in that it comprises at least a strap on its upper part forming a grip handle.

40. Sachet set forth in claim 39, characterised in that the strap is of cord type.

41. Machine for manufacturing double ply packaging sachets characterised in that it comprises:
means (92) capable of feeding through a first packaging sheet (31) and means (94) capable of cutting out or pre-cutting a window patch;
means (91) capable of feeding through a second packaging sheet (32) and means (93) capable of cutting out or pre-cutting a window patch;
means (95) capable of attaching a set of seals to a fed-through packaging sheet, perpendicular to the window patch;
means (96) capable of attaching the set of seals to the packaging sheet;
means (97) capable of attaching the two packaging sheets to each other in order to form a double ply sheet, and means for forming this sheet into a packaging sachet.

42. Machine set forth in claim 41, characterised in that the means for applying (95) the set of seals are transversally fed through in relation to the feed-through direction of the packaging sheet.

43. Machine set forth in claim 41, characterised in that the means for applying (95) the set of seals are longitudinally fed through in relation to the feed-through direction of the packaging sheet.
